(19) United States
(12) Patent Application Publication
(10) Pub. No.: US 2003/0140767 A1
(43) Pub. Date: Jul. 31, 2003

(54) Tuning device

(76) Inventor: Shigeki Yagi, Chiba-shi (JP)

Correspondence Address: ADAMS & WILKS, 31st Floor, 50 Broadway, New York, NY, 10004, US

(21) Appl. No.: 10/320,100

(22) Filed: Dec. 16, 2002

(30) Foreign Application Priority Data
Dec. 28, 2001 (JP) 2001-400458
Nov. 25, 2002 (JP) 2002-340254

(51) Int. Cl. G10G 7/02

(52) U.S. Cl. 84/454

(57) ABSTRACT

A tuning device is provided, which allows comfortable tuning operation and easy storage and efficiently samples only a target sound to be tuned. The tuning device is structured such that a vibration sensor is provided to a clip and the clip and a tuning state display portion are connected through a flexible joint. A piezoelectric element is used as the vibration sensor and also serves as a reference sound generator.

### BACKGROUND OF THE INVENTION

1. Field of the Invention

The present invention relates to a tuning device capable of tuning an arbitrary input sound using pitch information thereof.

2. Description of the Related Art

FIG. 4 shows a structure of a conventional tuning device. In the figure, a microphone 401 samples a sound and coverts the sound into an electrical signal. An amplifier 402 receives an output signal from the microphone 401 and amplifies the signal to a desired level. Pitch extracting means 403 receives an output signal from the amplifier 402 and extracts from the signal a fundamental period of the sound sampled by the microphone 401. On the other hand, a user presets a reference sound through reference sound setting means 404. Pitch error detecting means 405 receives an output from the pitch extracting means 403 and an output from the reference sound setting means 404 and calculates a pitch difference between the two outputs to output the result to pitch display means 406. Then, the pitch display means 406 visually displays the pitch difference between the reference sound and the target sound to be tuned. It is called a “tuning function” of the tuning device to indicate an index during the tuning of a musical instrument or the like with the above structure. In addition, the tuning device is equipped with reference sound generating means 407, which emits the reference sound set by the reference sound setting means 404, thereby allowing the user to hear the pitch of the reference sound to which the target sound should be in tune. This is called a “reference sound generating function”. The tuning function and the reference sound generating function can be selected optionally by the user through mode selector means 408. As the microphone 401, a small component such as a capacitor microphone is used. The pitch extracting means 403 is usually realized by a microcomputer and a memory which stores instructions, such as “measure the period of a fundamental wave component having the longest period in the input signal”. Similarly, the pitch error detecting means 405 is realized by a microcomputer and a memory which stores instructions, such as “to calculate the frequency difference between the input signals”. The amplifier 402, the memory, the microcomputer, and the like are mounted on a circuit board, which is contained within a main body of the tuning device (not shown). The reference sound setting means 404 is realized by a switch etc. The pitch display means 406 is realized by a meter, an LCD, a combination of plural LEDs, etc. FIG. 5 shows an external appearance of a general tuning device.

Up to now, it has been necessary to search for a position where the tuning device can efficiently sense the emitted target sound to be tuned before installing the tuning device. If a brass instrument is used for the tuning objective, a sound emitting side in the vicinity of a bell thereof is the most efficient position for sampling the sound. However, in most cases where the tuning device is placed in the above-mentioned position, the bell conceals a pitch display surface from view, which is shown in FIG. 6. In addition, if a musical instrument such as a trombone whose bell is far away from the eye of its player or a tuba whose bell is in a direction hard to be viewed by its player is used, it is difficult for the player to confirm a display showing a state of the tuning. Therefore, it has been devised that a contact microphone or the like is used to increase the degree of freedom in selecting a place for sampling the sound. FIG. 7 shows a state where tuning is being performed by using the contact microphone. On the other hand, there has been adopted a method of improving a sensitivity toward the sound to be sampled to thereby enhance the degree of freedom of position for installing the tuning device (for example, JP 2001-202080,A: Publication of patent application).

However, in the case of using the contact microphone, an electrical cord connecting a main body of the tuning device and the contact microphone becomes an obstacle, thereby deteriorating comfortability in tuning operation. Also, it requires time and labor to store the cord together with the other components of the tuning device. On the other hand, improvement of the sensitivity toward the sound to be sampled also improves the sensitivity toward the whole sounds on the periphery of the tuning device. Accordingly, there is often a case where detection is incorrect or the sound pitch cannot be judged when using the tuning device in a situation of playing in concert with other musical instruments or in a noisy environment such as the outdoors or a live house in which there exist sounds other than the target sound to be tuned.

### SUMMARY OF THE INVENTION

The present invention has been made to solve the above-mentioned problems and therefore has an object to provide a tuning device which allows comfortable tuning operation and easy storage and efficiently samples only a target sound to be tuned.

In order to solve the above-mentioned problems, according to the present invention, there is provided a tuning device, characterized by including: a clip for mounting the tuning device to a musical instrument, a vibration sensor that is provided to the clip, an electronic circuit for judging a state of a sound from the musical instrument by processing a signal obtained from the vibration sensor, which is connected to the clip via a joint portion; and a display portion for displaying a judgment result of the electronic circuit. This structure allows a simple and easy installation of the tuning device. In addition, the vibration sensor per se can efficiently detect the target sound to be tuned, whereby a satisfactory SN ratio of the input signal can be obtained.

Further, according to another aspect of the present invention, the tuning device is characterized in that the joint portion is a flexible joint so that a direction of the display portion can be changed. According to this structure, in whatever state the tuning device is installed, the tuning state can be clearly confirmed.

Further, according to another aspect of the present invention, the tuning device is characterized in that a piezoelectric element is used as the vibration sensor. By utilizing the piezoelectric element, the tuning device can be provided inexpensively.

Furthermore, according to another aspect of the present invention, the tuning device is characterized in that a piezoelectric element used as the vibration sensor also serves as a reference sound generator of the tuning device. Accordingly, the tuning device can be structured to be small.

### BRIEF DESCRIPTION OF THE DRAWINGS

In the accompanying drawings:

FIG. 1 is an external view of a tuning device according to Embodiment 1 of the present invention, which shows a state where a clip portion is opened;

FIG. 2 is an external view of the tuning device according to Embodiment 1 of the present invention, which shows an example of using a flexible tube as a flexible joint;

FIG. 3 is an external view of the tuning device according to Embodiment 1 of the present invention, which shows an example of using a universal joint as the flexible joint;

FIG. 4 is a diagram showing a structure of a conventional tuning device;

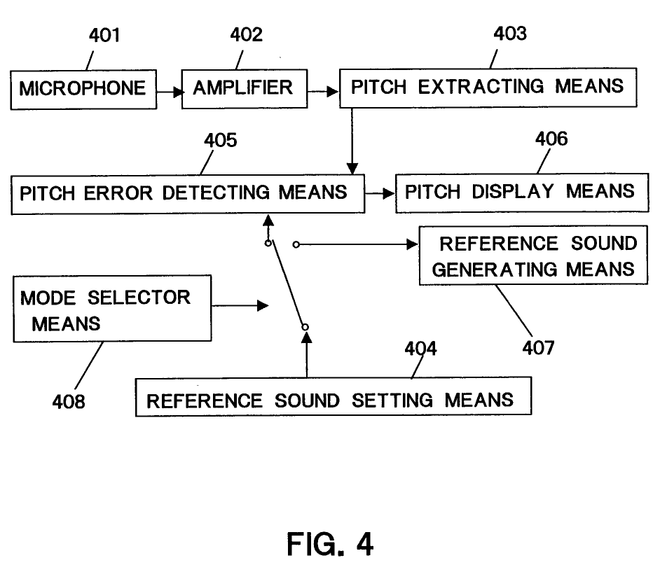

FIG. 5 is an external view of a general tuning device;

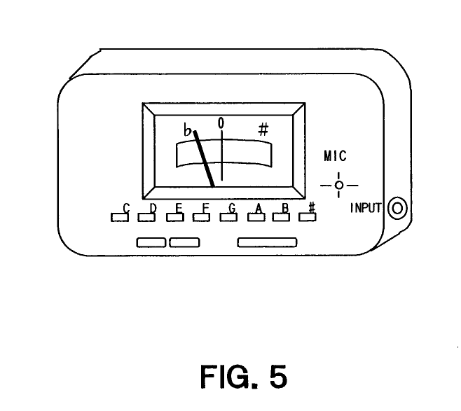

FIG. 6 is a diagram showing a state of using the conventional tuning device;

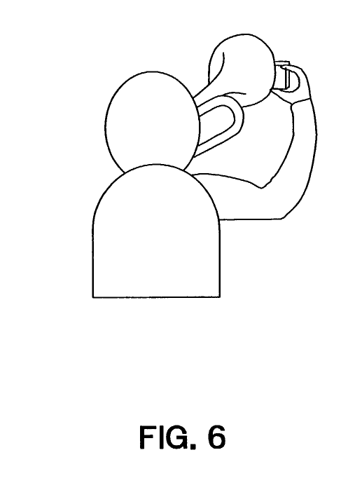

FIG. 7 is a diagram showing a state of using the conventional tuning device together with a contact microphone; and

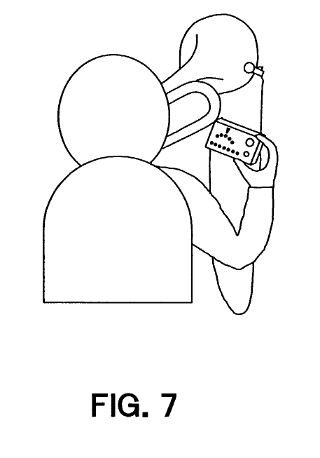

FIG. 8 is an external view of a tuning device according to Embodiment 3 of the present invention, which shows an example of using a pillow ball as a flexible joint.

### DETAILED DESCRIPTION OF THE PREFERRED EMBODIMENTS

Hereinbelow, embodiments of the present invention will be described based upon the accompanying drawings.

Embodiment 1

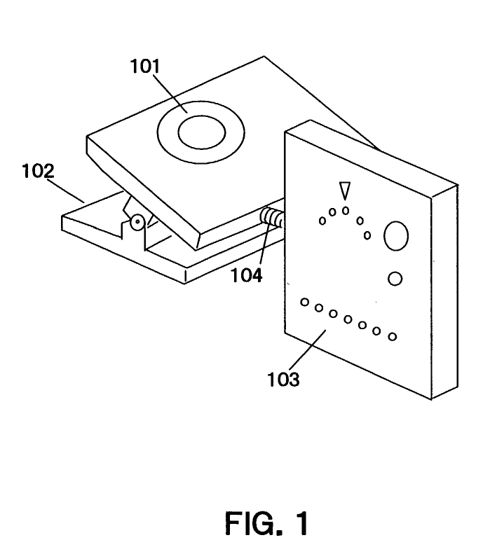

Embodiment 1 of the present invention is shown in FIG. 1. A clip portion 102 can pinch a resonant part of a sounding body by a pair of plate materials adapted to be engaged with each other and a repulsive force of a spring material disposed therebetween. As the spring material, for example, a plate spring, a coil spring, or the like is used. FIG. 1 shows a state where the clip portion 102 is opened. The clip portion 102 can pinch any rigid body that has a size equal to or smaller than the opening width thereof such as a part of a bell or a tube of a brass instrument or a neck of a guitar. It is usually possible for the clip portion 102 with a width of opening being approximately 6 cm to serve for tuning most kinds of musical instruments. The pinching force of the clip portion 102 needs to have an enough pressure to maintain stability of an entire tuning device according to an embodiment of the present invention, which may be approximately 5 N.

A vibration sensor 101 is disposed on the clip portion 102 so as to accurately detect a vibration state of the clip portion 102. A main body of the clip portion 102 is formed of a plastic molding, a metallic work, or the like which is made of a material having rigidity. In FIG. 1, the vibration sensor 101 is bonded to the upper surface of the clip portion 102. In some cases, the vibration sensor 101 is embedded within the main body of the clip portion 102 in order to protect the vibration sensor 101. In any case, it is essential that the vibration sensor 101 and the clip portion 102 are formed integrally for the purpose of sensing only a vibration for the detecting objective in the most efficient way and securing a satisfactory SN ratio of an input signal. As the vibration sensor 101, a capacitor microphone or a piezoelectric element can be used. In particular, the piezoelectric element is preferred because the piezoelectric element also includes a function to generate a reference sound from the tuning device. The piezoelectric element converts into an electrical signal a mechanical strain developed in the element due to the vibration. By utilizing the above-mentioned property, the vibration state can be recognized by way of the electrical signal. In addition, by utilizing other property that application of a voltage to the piezoelectric element develops a strain corresponding to varied values of the applied voltage in the piezoelectric element, a vibration in the audible range can be induced in the piezoelectric element to constitute a sound generator. In this embodiment, the piezoelectric element is used as the vibration sensor 101, and also at the same time, serves a role to generate the reference sound. Thus, a mounting space and a component cost for a vibration body, which corresponds to the vibration sensor and the sound generator, can be saved. As a result, the tuning device can be structured to be small, lightweight, and inexpensive.

A display portion 103 includes display means for displaying a tuning state on a surface thereof and is mounted therein with: an electronic circuit (not shown) for processing a signal obtained from the vibration sensor 101, judging the pitch of a sound, sending the judgment result to the display means, and sending the electrical signal for generating the reference sound to the sound generator; and a battery (not shown) for driving the electronic circuit. As the display means, a meter, a line of plural LEDs, an LCD display device, or the like is used. In this embodiment, the plural LEDs constitute the display means. A signal from the vibration sensor 101 is amplified to a desired level by an amplification circuit. The amplified signal is then inputted to pitch extracting means. The pitch extracting means is realized by a microcomputer and a memory which stores instructions, such as “measure the period of a fundamental wave component having the longest period in the input signal”. The pitch measured and a preset reference pitch are inputted into pitch error detecting means. The pitch error detecting means is realized by a microcomputer and a memory which stores instructions, such as “calculate the frequency difference between the input signals”. In accordance with a frequency deviation calculated above, a predetermined LED is turned on selectively from among the plural LEDs. As shown in FIG. 1, 5 LEDs are arrayed in a semicircular shape in the top left part of the surface of the display portion 103. For example, when the deviation between the reference pitch and the extracted pitch is less than ±3 cents, only the LED at the center (that is, the third left one) is turned on. When the extracted pitch is lower than the reference pitch by 3 cents or more and less than 10 cents, only the second left LED is turned on. When the extracted pitch is lower than the reference pitch by 10 cents or more, only the leftmost LED is turned on. Similarly, when the extracted pitch is higher than the reference pitch, only the fourth left LED or the fifth left LED is turned on corresponding to the extent of the pitch deviation.

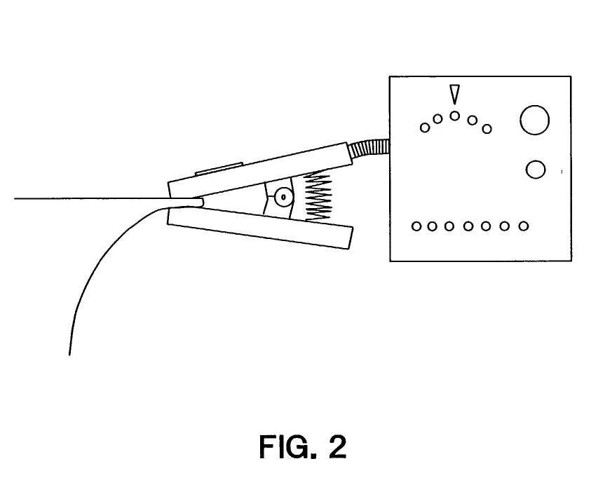

If the display portion 103 is connected fixedly to the clip portion 102, depending on a situation where the tuning device is fastened with a clip to a target sounding body, a surface of the tuning state display portion is faced toward a direction hard to be viewed by a user who is performing tuning. Therefore, the clip portion 102 and the display portion 103 are connected through a flexible joint 104, whereby after fastening the tuning device with a clip to the target sounding body, only the display portion 103 can be changed in position such that the surface of the tuning state display is faced toward a direction in which the tuning state can easily be confirmed. As the flexible joint, a flexible tube which is utilized for supporting a microphone etc., a universal joint which is utilized for supporting a fluorescent lamp etc., or the like can be used. In this embodiment, the flexible tube is used as a flexible joint and an example thereof is shown in FIG. 2.

Embodiment 2

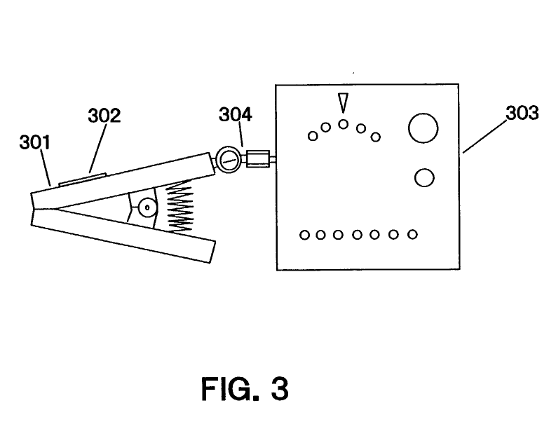

Embodiment 2 of the present invention is shown in FIG. 3. A structure including a clip portion 301, a vibration sensor 302, a display portion 303, and a flexible joint 304 is similar to that of Embodiment 1. Further, an LCD display device is used as the means for displaying a tuning state and a universal joint which is utilized for supporting a fluorescent lamp is used as the flexible joint 304.

Embodiment 3

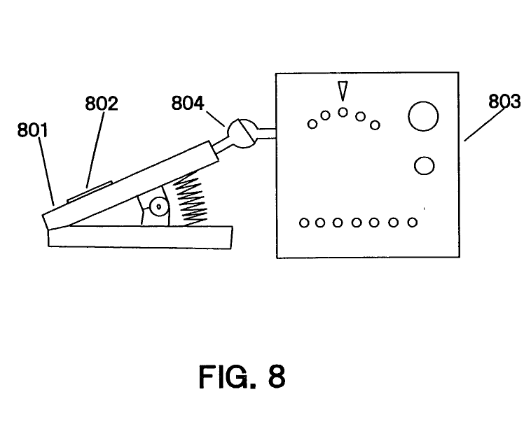

Embodiment 3 of the present invention is shown in FIG. 8. A structure including a clip portion 801, a vibration sensor 802, a display portion 803, and a flexible joint 804 is similar to that of Embodiment 1. Further, an LCD display device is used as the means for displaying a tuning state and a pillowball is used as the flexible joint 804.

As described above, according to the present invention, the tuning device adopts a structure in which the vibration sensor is provided to the clip and the clip and the tuning state display portion are connected with each other through the flexible joint. The piezoelectric element is used as the vibration sensor and also serves as the reference sound generator. Accordingly, the following effects are obtained.

1) The tuning device can be simply and easily installed.

2) In whatever state the tuning device is installed, the tuning state can be clearly confirmed.

3) The tuning device can be structured to be small and an accessory such as an electrical cord is unnecessary, thereby allowing easy storage and excellent portability and operability.

4) The tuning device can be realized by a structure using only a small amount of components, thereby enabling an inexpensive tuning device.

5) The vibration sensor per se can efficiently detect the target sound to be tuned, so that a satisfactory SN ratio of the input signal can be obtained. As a result, accurate extraction of the pitch of the target sound to be tuned can be realized and the incorrect detection due to the noise from the external environment can be prevented. Consequently, the accurate tuning operation can be realized even in a situation of playing in concert with other musical instruments or in a noisy environment such as the outdoors or the live house in which there exist sounds other than the target sound to be tuned.

What is claimed is:

1. A tuning device comprising:
a clip for mounting the tuning device to a musical instrument;
a vibration sensor that is provided to the clip;
an electronic circuit for judging a state of a sound from the musical instrument by processing a signal obtained from the vibration sensor, which is connected to the clip via a joint portion; and
a display portion for displaying a judgment result of the electronic circuit.

2. A tuning device according to claim 1, wherein the joint portion is a flexible joint so that a direction of the display portion can be changed.

3. A tuning device according to claim 1, wherein a piezoelectric element is used as the vibration sensor.

4. A tuning device according to claim 3, wherein the vibration sensor also serves as a reference sound generator of the tuning device.
